(19) United States
(12) Patent Application Publication
(10) Pub. No.: US 2026/0352551 A1
(43) Pub. Date: Nov. 5, 2026

(54) SIMULCAST COMMUNICATIONS FOR SMART RADIO DEVICES

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 19/098,244

(22) Filed: Apr. 2, 2025

(51) Int. Cl. H04L 41/0823; H04W 4/10; H04W 4/12

(52) U.S. Cl. CPC H04L 41/0836; H04W 4/10; H04W 4/12

(57) ABSTRACT

The present technology manages frontline worker communication from a smart radio device to one or more computing devices across multiple networks. Upon receiving data, the device duplicates it into multiple copies and encodes those copies for transmission using an MQTT protocol across different networks, enhancing communication reliability. The receiving one or more computing devices reconstruct the original data by selecting the first received packets from each duplicate and organizing each selected packet by timestamp. The device continuously streams data across the multiple networks as users move through varying network signal strengths, ensuring seamless communication.

### TECHNICAL FIELD

The present disclosure is generally related to wireless communication handsets and systems.

### BACKGROUND

Frontline workers often rely on radios to enable them to communicate with their team members. Traditional radios may fail to provide some communication services, requiring workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus for device communication and tracking, in accordance with one or more embodiments.

FIG. 2 is a block diagram illustrating an example apparatus for device communication and tracking, in accordance with one or more embodiments.

FIG. 3 is a block diagram illustrating an example charging station for apparatuses implementing device communication and tracking, in accordance with one or more embodiments.

FIG. 4A is a block diagram illustrating an example environment for apparatuses and communication networks for device communication and tracking, in accordance with one or more embodiments.

FIG. 4B is a flow diagram illustrating an example process for generating a work experience profile, in accordance with one or more embodiments.

FIG. 5 is a block diagram illustrating an example facility using apparatuses and communication networks for device communication and tracking, in accordance with one or more embodiments.

FIG. 6 illustrates an example of a worksite that includes a plurality of geofenced areas, in accordance with one or more embodiments.

FIG. 7 is a block diagram illustrating a smart radio device duplicating data for transmission across differing communication networks.

FIG. 8 is a block diagram illustrating an example worksite environment with differing signal strengths of differing communication networks across the worksite.

FIG. 9 is a flow diagram illustrating a process for smart radio device simulcast communication.

FIG. 10 is a block diagram illustrating an example computer system, in accordance with one or more embodiments.

### DETAILED DESCRIPTION

The disclosed technology relates techniques to improve the quality of service provided by frontline worker electronic devices through simulcasting data across multiple networks. Examples of frontline worker electronic devices include smart radio devices, smartphones, servers, and other Wi-Fi and/or cellular-compatible electronic devices. Examples of networks include Wi-Fi networks, public cellular networks, private cellular networks, and mesh networks. In the disclosed technology, the electronic devices can be connected to one or more networks at the same time.

With the disclosed technology, an electronic device can stream data from the electronic device to computing devices across the one or more networks connected to the electronic device. Examples of computing devices include other smart radios, smartphones, servers, and Wi-Fi and/or cellular-compatible electronic devices. The disclosed simultaneous streaming of data across multiple connected networks provides for seamless communication in areas where different types of networks offer inconsistent connectivity. For example, a frontline worker at a mine may interact with a variety of networks with a variety of connection strengths. The frontline worker may start the day with Wi-Fi in a small onsite office that offers a more reliable network than the public cellular network in that area. When the frontline worker leaves the office, the public cellular network may be the most reliable network until the frontline worker enters the mine. Once inside the mine, a private cellular network, built for the workers in the mine, may be the strongest connection possible.

The disclosed technology can stream data across each network connected to the electronic device, allowing the data to be sent across the most reliable network connected to the electronic device at any given time. For example, if the frontline worker at the mine is sending a voice message through a smart radio while they are walking from the onsite office to the entrance of the mine, the strongest network connection may switch from the Wi-Fi network, to the public cellular network, and to the private cellular network. In some embodiments, the disclosed technology streams data through a Message Queuing Telemetry Transport (MQTT) protocol. The MQTT protocol can have a topic associated with the one or more networks that, upon publishing data from the electronic device to the topic, transmit the data across the one or more networks to subscribers to the topic (e.g., computing devices).

In the disclosed technology, an electronic device streams across multiple connected networks by creating a duplication of the data to be sent for each network connected to the electronic device. For example, if a frontline worker intends to send a voice message while their smart radio is connected to a Wi-Fi network and a cellular network, the smart radio can duplicate the voice message data and simultaneously send each duplicate across the Wi-Fi network and the cellular network. In some embodiments, the computing device(s) receiving the data from the electronic device use a race condition to record the data such that the first data duplicate the computing device(s) receive is the data duplicate that gets recorded. Then, in some embodiments, any additional data duplicate received by the computing device from slower networks is discarded. For example, when the frontline worker sends a voice message while their smart radio is connected to a weak Wi-Fi network and a strong cellular network to another frontline worker's smart radio, the voice message data duplicate from the strong cellular network may reach the other frontline worker's smart radio first. When the Wi-Fi network voice message data duplicate reaches the other frontline worker's smart radio, their smart radio can discard the extra voice message duplicate.

In some embodiments, the electronic device and computing device(s) are compatible with Push-to-Three (PT3) technology. PT3 technology allows compatible devices, like smart radios, to send and receive text, audio, and video messages upon the push of a button. In some embodiments, the electronic device and computing device(s) of the disclosed technology are configured to send text, audio, and/or video messages when a Push-To-Talk (PTT) button of the electronic device and computing device(s) is pressed. In some embodiments the electronic device and computing device(s) of the disclosed technology are configured to receive text, audio, and/or video messages when a Push-To-Talk (PTT) button of the electronic device and computing device(s) is not pressed.

Mobile radio devices (e.g., smart radios) can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees'strengths and weaknesses. Accordingly, the present disclosure relates to improvements in mobile radio devices. In general, improvements are directed to one of four technical aspects (“pillars”): network connectivity, collaboration, location services, and data, which are explained below.
Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.
Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.
Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.
Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

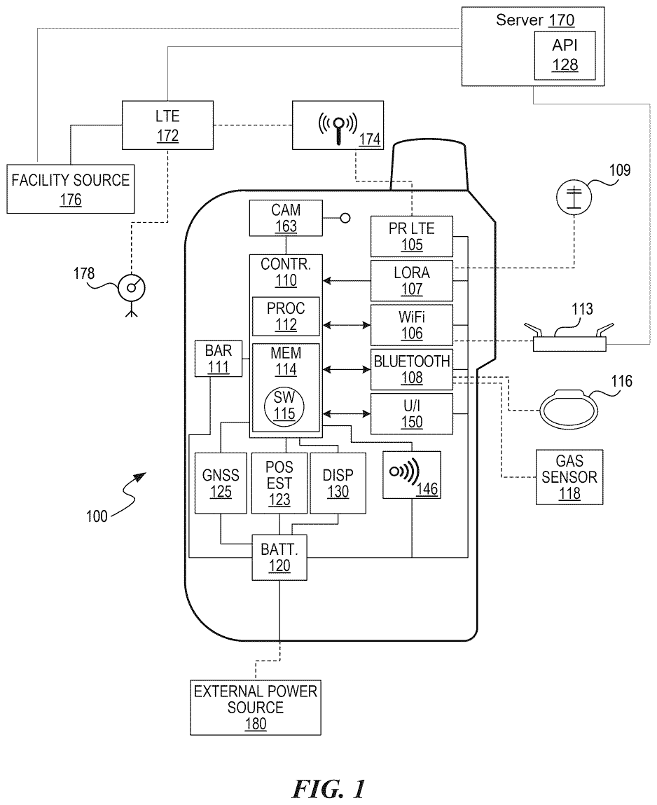

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

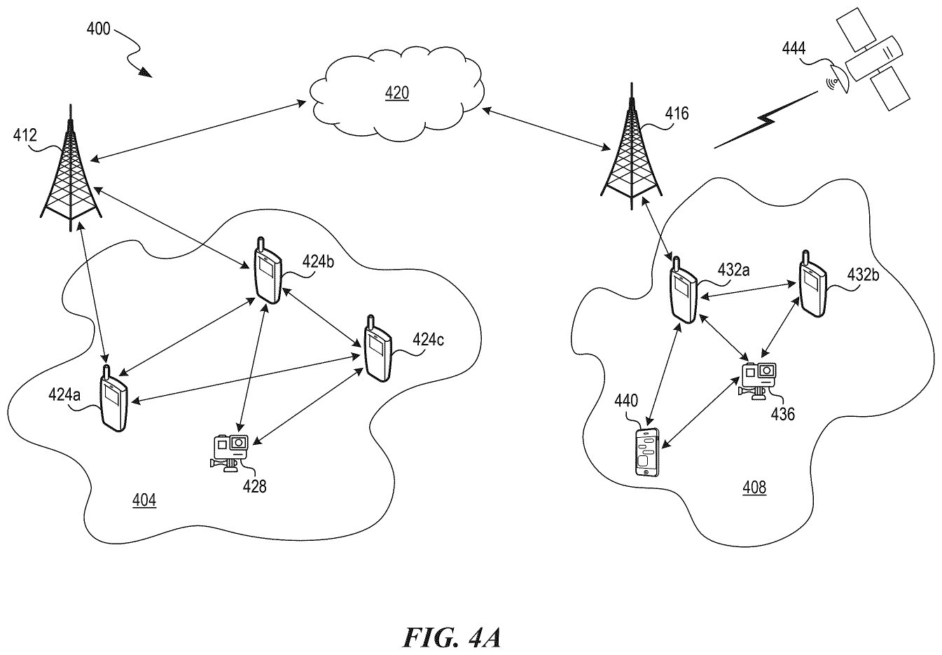

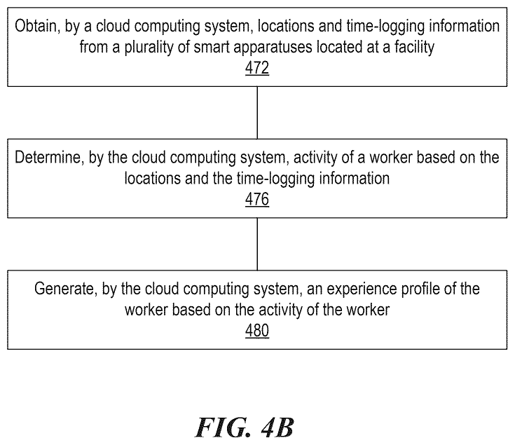

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100 (e.g., local network 404 illustrated in FIG. 4A). For example, the cellular type can be 2G, 3G, 4G, LTE, 5G, etc. The edge kit 172 is typically located near a facility's primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams™, Skype™, Zoom™, Cisco Webex™). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The apparatus 100 communicates with a host server 170 which includes API software 128. The apparatus 100 communicates with the host server 170 via the Internet using pathways such as the Wi-Fi subsystem 106 through an access point 113 and/or the wireless antenna 174. The API 128 communicates with onboard software 115 to execute features disclosed herein.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker's position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker's profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

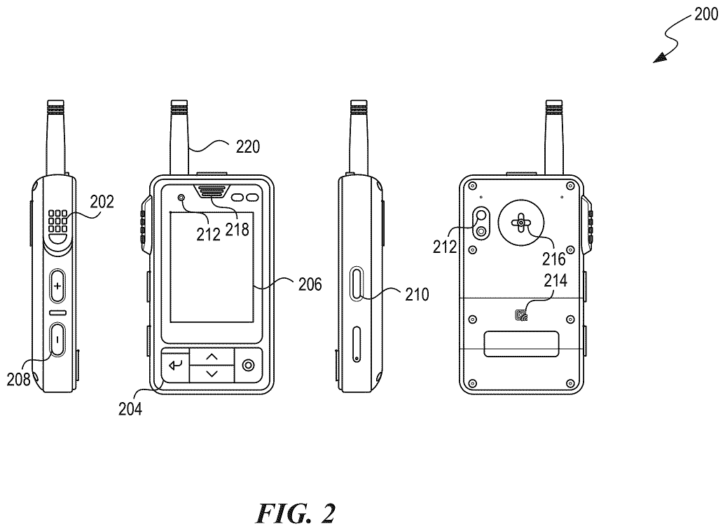

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a workers badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

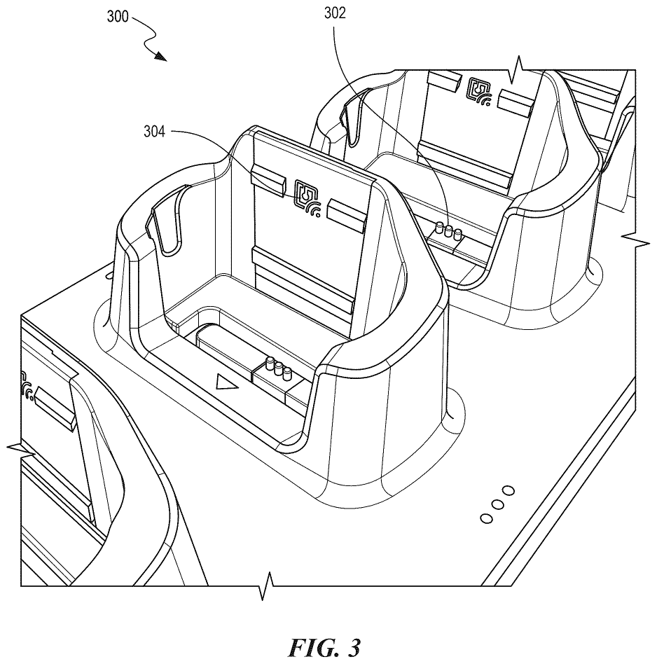

FIG. 3 is a drawing illustrating an example charging station 300 for apparatuses implementing device communication and tracking, in accordance with one or more embodiments. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

FIG. 4A is a drawing illustrating an example environment 400 for apparatuses and communication networks for device communication and tracking, in accordance with one or more embodiments. The environment 400 includes a cloud computing system 420, cellular transmission towers 412, 416, and local networks 404, 408. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, or T-Mobile™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio's speaker.

For example, the smart radio 424a broadcasts voice data using radio signals. Any other smart radio 424 b within a range limit (e.g., 1 mile, 2 miles, etc.) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VoIP), Voice over Wi-Fi (VoWiFi), or Voice over Long-Term Evolution (VoLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services—including servers, storage, databases, networking, software, analytics, and intelligence—over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on-or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver's distance from multiple transmitters, the receiver's position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices shares their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it's located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 424b can be improved by augmenting the primary location estimate with the secondary location estimate.

In some implementations, The location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

At 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

At 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

At 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn™, Monster™, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

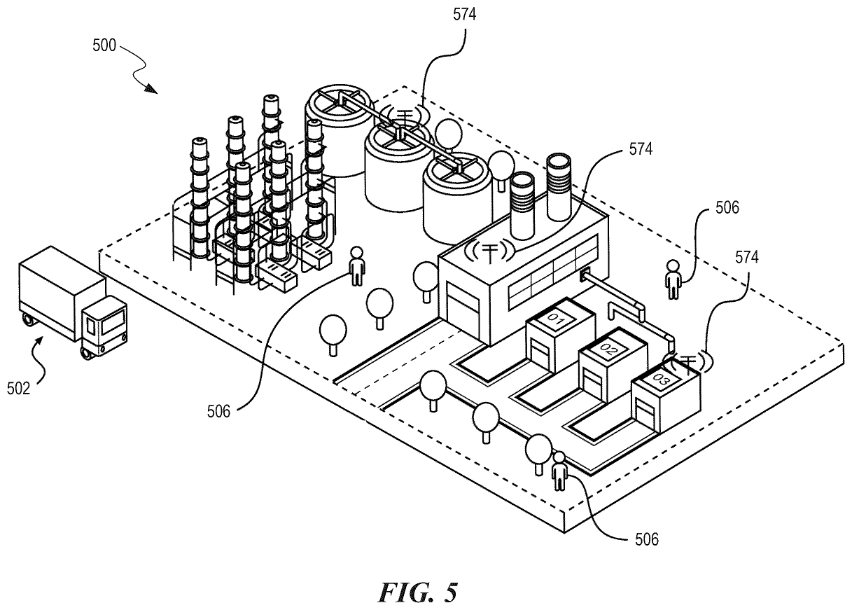

FIG. 5 is a drawing illustrating an example facility 500 using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas' directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHz) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

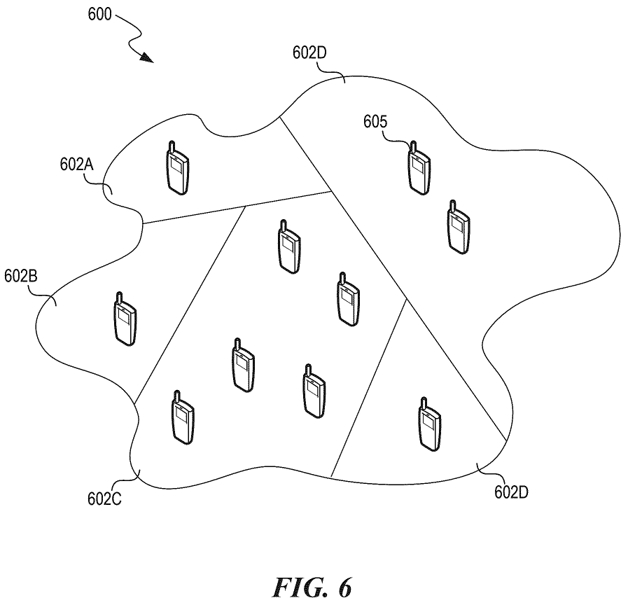

According to some embodiments, locations of smart radios are monitored such that at a point in time, each smart radio located in a specific geofenced area is identified. FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the plurality of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### Simulcast Communications

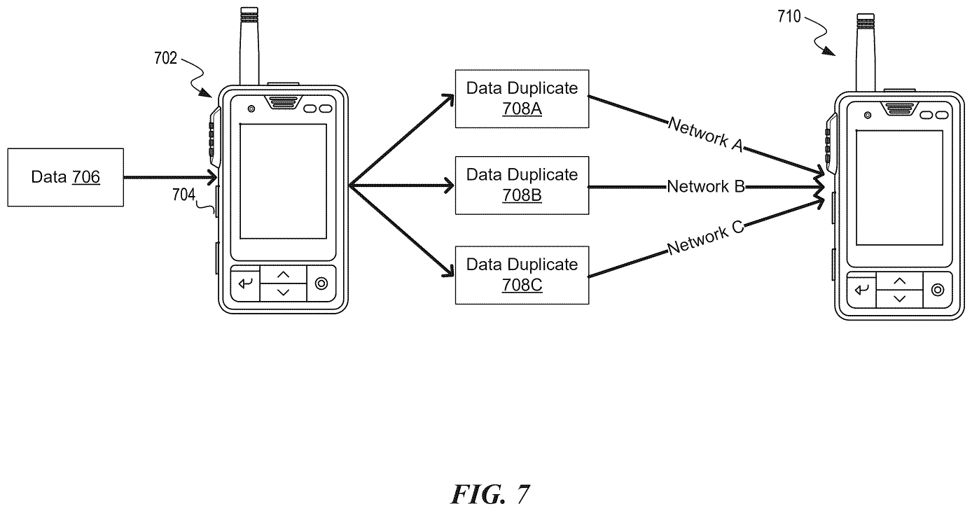

FIG. 7 is a block diagram illustrating a smart radio device 702 with Push-To-Talk (PTT) button 704 duplicating data 706 into three data duplicates (708A, 708B, and 708C) for simultaneous transmission across differing communication networks (Network A, Network B, and Network C) to computing device 710. Smart radio device 702 is a frontline worker electronic device for communication throughout a worksite. In some embodiments, however, smart radio device 702 is instead an electronic device comprising a smartphone, a server, or other Wi-Fi and/or cellular-compatible electronic devices. In the disclosed technology, smart radio device 702 can be connected to multiple communication networks (e.g., Network A, Network B, and Network C) at the same time. These communication networks can each be distinct communication networks including public cellular networks, Wi-Fi networks, private cellular networks, mesh networks, etc.

As shown, smart radio device 702 receives data 706. Data 706 can be a text file, and image file, an audio file, a video file, or a combination thereof. Data 706 can be input to smart radio device 702 externally or generated by smart radio device 702 itself. For example, a user may speak into smart radio device 702 and the smart radio device 702 can generate an audio file (represented as data 706) based on that speech. In another example, smart radio device 702 can receive a text input from an external source (e.g., a user of smart radio device 702).

Once the smart radio device 702 obtains data 706, smart radio device 702 duplicates data 706 into data duplicates 708A, 708B, and 708C. This duplication allows data 706 to be transmitted separately to computing device 710 across each communication network (e.g., Network A, Network B, and Network C) connected to the smart radio device 702. Transmitting data 706, via data duplicates 708A, 708B, and 708C, across multiple communication networks can increase communication reliability. For example, if a frontline worker using smart radio device 702 is sending a voice message to computing device 710 through a smart radio while they are walking from a worksite office to an entrance of a mine, the strongest network connection may switch from the Wi-Fi network, to the public cellular network, and to the private cellular network.

In some embodiments, smart radio device 702 is configured to obtain data 706 when a PTT button 704 of the smart radio device 702 is actuated. For example, when a user of smart radio device 702 presses PTT button 704, smart radio device 702 can be configured to record audio of the user. Upon a second actuation of PTT button 704 (e.g., a release of the button), smart radio device 702 is configured to duplicate, encode, and transmit data 706 across one or more communication networks. In some embodiments, smart radio device 702 is configured to continuously duplicate, encode, and transmit data 706 while the user of smart radio device 702 is inputting data (e.g., the user is talking into the smart radio device and the device duplicates, encodes, and transmits the audio as the user is talking). In other embodiments, smart radio device 702 is configured to receive transmitted data duplicates when PTT button 704 is not pressed.

The disclosed technology can simultaneously stream data duplicates 708A over Network A, 708B over Network B, and 708C over Network C via a Message Queuing Telemetry Transport (MQTT) protocol. MQTT is a lightweight messaging protocol designed for constrained devices and low-bandwidth, high-latency, or unreliable networks. MQTT uses a publish/subscribe messaging model, which decouples the sender (a publisher) from the receiver (a subscriber). This model allows for efficient and scalable communication. In MQTT, messages are published to topics. A topic is a hierarchical string that represents a specific subject or channel. A subscriber can express interest in one or more topics by subscribing to those topics. Then, when a message is published to a subscribed topic, the message is transmitted to the subscriber. In the disclosed technology, an MQTT topic can be associated with one or more networks (e.g., Network A, Network B, and Network C). Thus, when a messaged is published to a topic, the topic may send the message across a variety of networks. For example, a floor worker at a worksite using smart radio device 702 may seek to publish data 706 to a topic “floor workers of worksite.” If the smart radio device 702 is connected to Network A, Network B, and Network C, then smart radio device 702 can create three data duplicates (708A, 708B, and 708C) and send each data duplicate simultaneously and separate across a each network to all subscribers of the topic “floor workers of worksite” (e.g., other smart radios of workers on the worksite floor).

In some embodiments, prior to duplicating data 706, the smart radio device 702 can detect the number of communication networks connected to smart radio device 702 (e.g., the number of communication networks associated with a particular MQTT topic). Then, based on the number of communication networks detected, smart radio device 702 can duplicate data 706 into a corresponding number of data duplicates. In other embodiments, smart radio device 702 can detect the signal strength of each communication network connected to smart radio device 702 and, in response to detecting that a communication network's signal strength is below a threshold signal strength, reduce the number of data duplicates created. In yet further embodiments, the smart radio device 702 can detect the signal strength of each communication network connected to smart radio device 702 and, in response to detecting that a communication network's signal strength exceeds a threshold (e.g., a strength threshold above which risk of transmission failure is zero or near zero), forgo duplicating data 706.

Upon duplication, and prior to MQTT transmission, each data duplicate 708A, 708B, and 708C is encoded by smart radio device 702 to prepare for transmission across Network A, Network B, and Network C. In the disclosed technology, each data duplicate encoded creates a sequence of data packets corresponding to that data duplicate. For example, encoding data duplicate 708A creates a 708A data packet sequence. Each sequence of data packets includes an identical number of data packets with an identical series of identifiers and timestamps. For example, a 708A data packet sequence and a 708B data packet sequence may both include 10 data packets with identifiers 1-10 and a timestamp for each second (e.g., second 0, second 1, second 2, etc.). In some embodiments, the data duplicates 708A, 708B, and 708C are duplicates of an audio file and are encoded through the Advanced Audio Coding (AAC) format. In other embodiments, the data duplicates 708A, 708B, and 708C are encoded through a variety of encoding formats including American Standard Code for Information Interchange (ASCII), Waveform Audio File Format (WAV), Advanced Video Coding (H.264), Joint Photographic Experts Group (JPEG), etc. Similarly, in other embodiments, the identifiers of each data packet of the data packet sequences can be a variety of identifier types including sequence numbers, IP packet identifiers, acknowledgement numbers, Service Set Identifiers (SSID), Audio Data Transport Stream (ADTS) Header, Packet Identifiers, etc.

In FIG. 7, smart radio device 702 simultaneously transmits data duplicates 708A, 708B, and 708C to computing device 710 across Network A, Network B, and Network C. In some embodiments, smart radio device 702 simultaneously transmits data duplicates 708A, 708B, and 708C to a plurality of computing devices across Network A, Network B, and Network C. Computing device 710 can include a second smart radio device, a smartphone, a server, a computing system of a machine, and other Wi-Fi and/or cellular-compatible electronic devices.

Computing device 710 is configured to receive each transmitted data duplicate and reconstruct data 706 based on a race condition for each data packet received from the sequence of data packets corresponding to each transmitted data duplicate. Specifically, computing device 710 records, for each identifier, the first data packet received from each transmitted data duplicate. For example, if data duplicates 708A, 708B, and 708C, each having 10 data packets and identifiers A-J, are transmitted to computing device 710, computing device 710 will record the first received data packet from the three data duplicates containing the identifier A, the first received data packet from the three data duplicates containing the identifier B, and so on through identifier J. All data packets received by computing device 710 with an identifier already recorded are discarded. As such, following the example above, at the end of transmission, computing device 710 records 10 data packets with identifiers A-J, but those data packets may have come from a combination of data duplicates 708A, 708B, and 708C. To complete reconstruction of data 706, computing device orders the recorded data packets based on the timestamps of each data packet. For example, if a data packet with identifier A has a time stamp of second 0, and another data packet with identifier B has a time stamp of second 1, then computing device 710 may order the data packet with identifier A first and the data packet with identifier B second. The above described reconstruction can be carried out by a decoder of computing device 710.

In some embodiments, upon reconstruction of data 706, from data duplicates 708A, 708B, and 708C, by computing device 710, computing device 710 is caused to present the reconstructed data 706 to a user of computing device 710. For example, if computing device 710 is a smart radio and data 706 is an audio message, computing device 710 may be caused automatically to present the audio message through a speaker of computing device 710.

The process described above with respect to simultaneous transmission of data from smart radio device 702 to computing device 710 across multiple communication networks may also happen in reverse. As such, in some embodiments, smart radio device 702 is configured to receive multiple data duplicates across multiple communication networks and reconstruct the data, resulting in the original data transmitted by computing device 710.

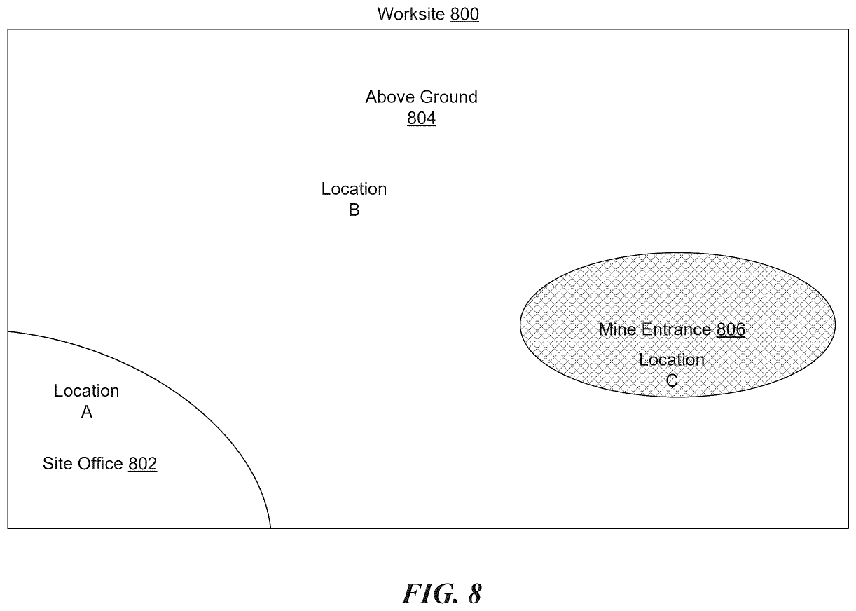

FIG. 8 is a block diagram illustrating an example worksite environment with differing signal strengths of differing communication networks across the worksite. In FIG. 8, worksite 800 includes site office 802, above ground 804, and mine entrance 806. Additionally, FIG. 8 includes Location A, Location B, and Location C, which correspond to a location of a smart radio device (e.g., a smart radio device as described with respect to FIG. 7 above) as a user moves throughout worksite 800 with the smart radio device. Location A in site office 802 has a strong Wi-Fi network connection, Location B within above ground 804 has a strong public cellular network connection, and Location C at the mine entrance 806 has a strong private cellular network connection.

As the user carries the smart radio device between Location A, Location B, and Location C, the smart radio device can continually stream data to one or more computing devices across the networks connected to the smart radio device. For example, the user may be speaking instructions into the smart radio device as the user walks from Location A to Location B. As the user walks between Location A and Location B, the networks connected to the smart radio device (e.g., the networks associated with a particular MQTT topic) with the strongest signal change. Differences in signal strength can impact how quickly data is communicated over a network- or if the data is communicated all together. In the disclosed technology, however, regardless of location, the smart radio device transmits any communication from the smart radio device to another device over every connected communication network simultaneously. Thus, as the user moves throughout the worksite, the data the user seeks to send (e.g., audible instructions) will be transmitted to the one or more computing devices across whichever network has the strongest signal strength, as well as the other connected networks.

The one or more computing devices are configured to receive the data as described with respect to FIG. 7 above. The computing devices include a race condition that allows the computing devices to reconstruct the data based on whichever portions of the data reach the computing device first (e.g., data packet one from data sent across network one and data packet two from data sent across network 3). As such, as a user of the smart radio device moves across the worksite (e.g., Location B to Location C) and the speed at which data is sent across each network changes, the receiving one or more computing devices still efficiently and reliable piece together the data sent by the user.

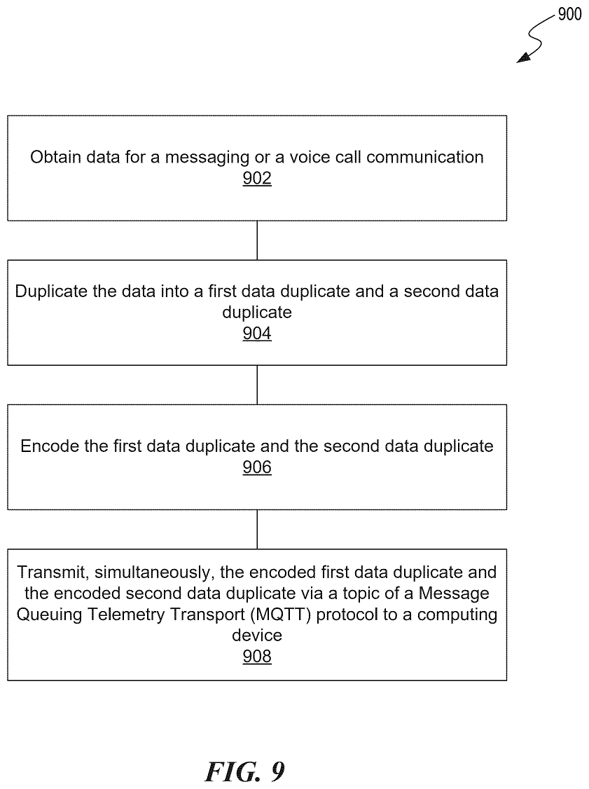

FIG. 9 is a flow diagram illustrating a process for smart radio device simulcast communication. At 902 the smart radio device obtains data (e.g., the smart radio device 702 obtains data 706 in FIG. 7) for a messaging or a voice call communication. This data can be obtained at a smart radio device that is one of multiple smart radio device hosted by a server for managing communications of workers at a worksite. In some embodiments, data can be obtained by an electronic device (e.g., the computing device 710 in FIG. 7) comprising a smartphone, a server, or other Wi-Fi and/or cellular-compatible electronic devices. The data comprises one or more of a text file, an image file, an audio file, and a video file.

In some embodiments, the smart radio device can detect a first actuation of a Push-To-Talk (PTT) button on the smart radio device and, in response to detecting the first actuation of the PTT button, receive the data. In other embodiments, the smart radio device can generate the data by receiving an input (e.g., an audible input or a text input) and transforming the input to a digital form.

At 904, the smart radio device duplicates the data into a first data duplicate and a second data duplicate. In some embodiments, the smart radio device duplicates the data into the first data duplicate and the second data duplicate. In other embodiments, the smart radio device is configured to detect a second actuation of the PTT button on the smart radio device and, in response to detecting a second actuation of the PTT button, duplicate the data into the first data duplicate and the second data duplicate. Further, the smart radio device can be configured to, upon the second actuation of the PTT button, encode the first data duplicate and the second data duplicate as in step 906 and transmit, simultaneously, the encoded first data duplicate and the encoded second data duplicate via the topic of the MQTT protocol to the computing device as in step 908.

At 906 the smart radio device encodes the first data duplicate and the second data duplicate (e.g., the data duplicates 708A, 708B, 708C in FIG. 7). In some embodiments, the smart radio device encodes the first data duplicate and the second data duplicate. Encoding the first data duplicate creates a first sequence of data packets and encoding the second data duplicate creates a second sequence of data packets. Each sequence of data packets includes an equal number of data packets. Each data packet of the first sequence of data packets includes a timestamp and an identifier. Each data packet of the second sequence of data packets includes a duplicate timestamp and a duplicate identifier corresponding to each data packet of the first sequence of data packets.

At 908 the smart radio device transmits simultaneously the encoded first data duplicate and the encoded second data duplicate via a topic of a Message Queuing Telemetry Transport (MQTT) protocol to a computing device. The topic of the MQTT protocol is associated with a first communication network and a second communication network (e.g., the networks A, B, C in FIG. 7), the first communication network and the second communication network being of differing types. For example, the first communication network and the second communication network can be distinct networks selected from a Wi-Fi network, a public cellular network, a private cellular network, and a mesh network. The encoded first data duplicate is transmitted to the computing device across the first communication network and the encoded second data duplicate is transmitted to the computing device across the second communication network. The first communication network and the second communication network can be predefined, e.g., as part of configuring the MQTT protocol for the smart radio device. The first communication network and the second communication network are, for example, selected from among a set of communication networks that the smart radio device has access to (e.g., the smart radio device has a subscription to the first and second communication networks). The computing device is configured to receive the encoded first data duplicate and the encoded second data duplicate and reconstruct the data using whichever of the encoded first data duplicate and the encoded second data duplicate was received first in time by the computing device. The computing device can be a second smart radio device, a server, or a computing system of a machine.

In some embodiments, the smart radio device causes the computing device to reconstruct the data (e.g., as a result of transmitting the first and second data duplicates to the computing device). The computing device reconstructs the data by recording, for each identifier and corresponding duplicate identifier, a first received data packet and combining each of the first received data packets based on the timestamp of each of the first received data packets. The first received data packet is a data packet of the first sequence of data packets or the second sequence of data packets. Further, for each identifier and corresponding duplicate identifier, any subsequently received data packets are discarded.

In some embodiments, the smart radio device is configured to receive, simultaneously, a third data duplicate and a fourth data duplicate via the topic of the MQTT protocol from the computing device. As before, the topic is associated with the first communication network and the second communication network. The third data duplicate is transmitted across the first communication network and the fourth data duplicate is transmitted across the second communication network. The smart radio device is further configured to reconstruct data sent by the computing device based on the third data duplicate and the fourth data duplicate as described above with respect to the first and second data duplicates.

### Computing System

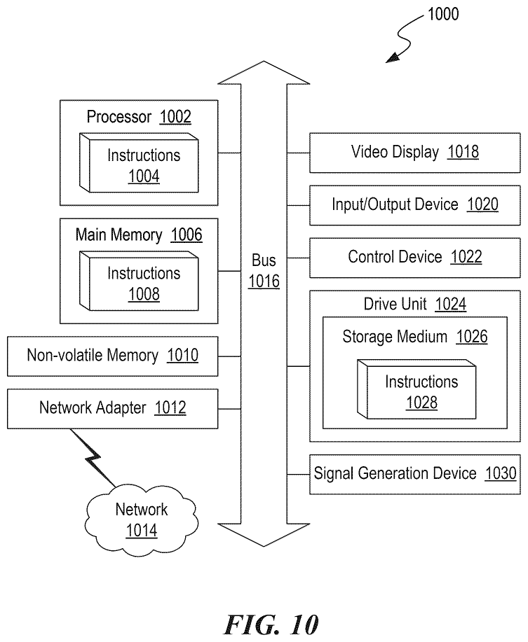

FIG. 10 is a block diagram illustrating an example computer system 1000, in accordance with one or more embodiments. At least some operations described herein are implemented on the computer system 1000. The computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1030 that are communicatively connected to a bus 1016. The bus 1016 is illustrated as an abstraction that represents one or more physical buses and/or point-to-point connections that are connected by appropriate bridges, adapters, or controllers. In embodiments, the bus 1016 includes a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an IEEE standard 1394 bus (also referred to as “Firewire”).

In embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The terms “machine-readable medium” and “storage medium” shall also be taken to include any medium that is capable of storing, encoding, or carrying a set of instructions for execution by the computer system 1000.

In general, the routines executed to implement the embodiments of the disclosure are implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by the one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1010, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. In embodiments, the network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In embodiments, the network adapter 1012 includes a firewall that governs and/or manages permission to access proxy data in a computer network and tracks varying levels of trust between different machines and/or applications. In embodiments, the firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall additionally manages and/or has access to an access control list that details permissions including the access and operation rights of an object by an individual, a machine, and/or an application, and the circumstances under which the permission rights stand.

In embodiments, the functions performed in the processes and methods are implemented in differing order. Furthermore, the outlined steps and operations are only provided as examples. For example, some of the steps and operations are optional, combined into fewer steps and operations, or expanded into additional steps and operations without detracting from the essence of the disclosed embodiments.

In embodiments, the techniques introduced here are implemented by programmable circuitry (e.g., one or more microprocessors), software and/or firmware, special-purpose hardwired (i.e., non-programmable) circuitry, or a combination of such forms. In embodiments, special-purpose circuitry is in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. It will be appreciated that the same thing can be said in more than one way. One will recognize that “memory” is one form of a “storage” and that the terms are on occasion used interchangeably.

Consequently, alternative language and synonyms are used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

1. A smart radio device comprising:
at least one hardware processor; and
at least one non-transitory memory storing instructions, which, when executed by the at least one hardware processor, cause the smart radio device to:
obtain data for a messaging or a voice call communication,
wherein the smart radio device is one of multiple smart radio devices hosted by a server for managing communications of workers at a worksite;
duplicate the data into a first data duplicate and a second data duplicate;
encode the first data duplicate and the second data duplicate; and
transmit, simultaneously, the encoded first data duplicate and the encoded second data duplicate via a topic of a Message Queuing Telemetry Transport (MQTT) protocol to a computing device,
wherein the topic is associated with a first communication network and a second communication network, the first communication network and the second communication network being of differing types;
wherein the encoded first data duplicate is transmitted to the computing device across the first communication network and the encoded second data duplicate is transmitted to the computing device across the second communication network, and
wherein the computing device is configured to receive the encoded first data duplicate and the encoded second data duplicate and reconstruct the data using whichever of the encoded first data duplicate and the encoded second data duplicate was received first in time by the computing device.

2. The smart radio device of claim 1, the smart radio device is further caused to:
encode the first data duplicate and the second data duplicate,
wherein encoding the first data duplicate creates a first sequence of data packets and encoding the second data duplicate creates a second sequence of data packets, the first and second sequence of data packets including an equal number of data packets;
wherein each data packet of the first sequence of data packets, includes a timestamp and an identifier;
wherein each data packet of the second sequence of data packets include a duplicate timestamp and a duplicate identifier corresponding to each data packet of the first sequence of data packets; and
cause the computing device to reconstruct the data, the reconstructing comprising:
recording, for each identifier and corresponding duplicate identifier, a first received data packet,
wherein the first received data packet is a data packet of the first sequence of data packets or the second sequence of data packets;
discarding, for each identifier and corresponding duplicate identifier, a subsequently received data packet; and
combining each of the first received data packets based on the timestamp of each of the first received data packets.

3. The smart radio device of claim 1, the smart radio device is further caused to:
receive, simultaneously, a third data duplicate and a fourth data duplicate via the topic of the MQTT protocol from the computing device,
wherein the topic is associated with the first communication network and the second communication network;
wherein the third data duplicate is transmitted across the first communication network and the fourth data duplicate is transmitted across the second communication network.

4. The smart radio device of claim 1, the smart radio device is further caused to:
detect a first actuation of a Push-To-Talk (PTT) button on the smart radio device; and
receive the data in response to detecting the first actuation of the PTT button.

5. The smart radio device of claim 4, the smart radio device is further caused to:
detect a second actuation of the PTT button on the smart radio device; and
in response to detecting a second actuation of the PTT button, duplicate the data into the first data duplicate and the second data duplicate, encode the first data duplicate and the second data duplicate, and transmit, simultaneously, the encoded first data duplicate and the encoded second data duplicate via the topic of the MQTT protocol to the computing device.

6. The smart radio device of claim 1, wherein the computing device comprises:
a second smart radio device;
a server; or
a computing system of a machine.

7. The smart radio device of claim 1, wherein the first communication network and the second communication network are selected from a Wi-Fi network, a public cellular network, a private cellular network, and a mesh network.

8. The smart radio device of claim 1, wherein the data comprises one or more of a text file, an image file, an audio file, and a video file.

9. The smart radio device of claim 1, the smart radio device is further caused to:
generate the data, the generating comprising:
receiving an input,
wherein the input is an audible input or a text input; and
transforming the input to a digital form.

10. A method comprising:
obtaining data, by a smart radio device, for a messaging or a voice call communication,
wherein the smart radio device is one of multiple smart radio devices hosted by a server for managing communications of workers at a worksite;
duplicating the data into a first data duplicate and a second data duplicate;
encoding the first data duplicate and the second data duplicate; and
transmitting, simultaneously, the encoded first data duplicate and the encoded second data duplicate via a topic of a Message Queuing Telemetry Transport (MQTT) protocol to a computing device,
wherein the topic is associated with a first communication network and a second communication network, the first communication network and the second communication network being of differing types;
wherein the encoded first data duplicate is transmitted to the computing device across the first communication network and the encoded second data duplicate is transmitted to the computing device across the second communication network, and
wherein the computing device is configured to receive the encoded first data duplicate and the encoded second data duplicate and reconstruct the data using whichever of the encoded first data duplicate and the encoded second data duplicate was received first in time by the computing device.

11. The method of claim 10, further comprising:
encoding the first data duplicate and the second data duplicate,
wherein encoding the first data duplicate creates a first sequence of data packets and encoding the second data duplicate creates a second sequence of data packets, the first and second sequence of data packets including an equal number of data packets;
wherein each data packet of the first sequence of data packets, includes a timestamp and an identifier;
wherein each data packet of the second sequence of data packets include a duplicate timestamp and a duplicate identifier corresponding to each data packet of the first sequence of data packets; and
causing the computing device to reconstruct the data, the reconstructing comprising:
recording, for each identifier and corresponding duplicate identifier, a first received data packet,
wherein the first received data packet is a data packet of the first sequence of data packets or the second sequence of data packets;
discarding, for each identifier and corresponding duplicate identifier, a subsequently received data packet; and
combining each of the first received data packets based on the timestamp of each of the first received data packets.

12. The method of claim 10, further comprising:
receiving, simultaneously, a third data duplicate and a fourth data duplicate via the topic of the MQTT protocol from the computing device,
wherein the topic is associated with the first communication network and the second communication network;
wherein the third data duplicate is transmitted across the first communication network and the fourth data duplicate is transmitted across the second communication network.

13. The method of claim 10, further comprising:
detecting a first actuation of a Push-To-Talk (PTT) button on the smart radio device;
receiving the data in response to detecting the first actuation of the PTT button;
detecting a second actuation of the PTT button on the smart radio device; and
in response to detecting a second actuation of the PTT button, duplicating the data into the first data duplicate and the second data duplicate, encode the first data duplicate and the second data duplicate, and transmit, simultaneously, the encoded first data duplicate and the encoded second data duplicate via the topic of the MQTT protocol to the computing device.

14. The method of claim 10, wherein the first communication network and the second communication network are selected from a Wi-Fi network, a public cellular network, a private cellular network, and a mesh network.

15. The method of claim 10, further comprising:
generating the data, the generating comprising:
receiving an input,
wherein the input is an audible input or a text input; and
transforming the input to a digital form.

16. A non-transitory, computer-readable storage medium comprising instructions recorded thereon, wherein the instructions, when executed by at least one data processor of a system, cause the system to:
obtain data, by a smart radio device, for a messaging or a voice call communication,
wherein the smart radio device is one of multiple smart radio devices hosted by a server for managing communications of workers at a worksite;
duplicate the data into a first data duplicate and a second data duplicate;
encode the first data duplicate and the second data duplicate; and
transmit, simultaneously, the encoded first data duplicate and the encoded second data duplicate via a topic of a Message Queuing Telemetry Transport (MQTT) protocol to a computing device,
wherein the topic is associated with a first communication network and a second communication network, the first communication network and the second communication network being of differing types;
wherein the encoded first data duplicate is transmitted to the computing device across the first communication network and the encoded second data duplicate is transmitted to the computing device across the second communication network, and
wherein the computing device is configured to receive the encoded first data duplicate and the encoded second data duplicate and reconstruct the data using whichever of the encoded first data duplicate and the encoded second data duplicate was received first in time by the computing device.

17. The non-transitory, computer-readable storage medium of claim 16, the system being further caused to:
encode the first data duplicate and the second data duplicate,
wherein encoding the first data duplicate creates a first sequence of data packets and encoding the second data duplicate creates a second sequence of data packets, the first and second sequence of data packets including an equal number of data packets;
wherein each data packet of the first sequence of data packets, includes a timestamp and an identifier;
wherein each data packet of the second sequence of data packets include a duplicate timestamp and a duplicate identifier corresponding to each data packet of the first sequence of data packets; and
cause the computing device to reconstruct the data, the reconstructing comprising:
recording, for each identifier and corresponding duplicate identifier, a first received data packet,
wherein the first received data packet is a data packet of the first sequence of data packets or the second sequence of data packets;
discarding, for each identifier and corresponding duplicate identifier, a subsequently received data packet; and
combining each of the first received data packets based on the timestamp of each of the first received data packets.

18. The non-transitory, computer-readable storage medium of claim 16, the system being further caused to:
receive, simultaneously, a third data duplicate and a fourth data duplicate via the topic of the MQTT protocol from the computing device,
wherein the topic is associated with the first communication network and the second communication network;
wherein the third data duplicate is transmitted across the first communication network and the fourth data duplicate is transmitted across the second communication network.

19. The non-transitory, computer-readable storage medium of claim 16, the system being further caused to:
detect a first actuation of a Push-To-Talk (PTT) button on the smart radio device; and
receive the data in response to detecting the first actuation of the PTT button;
detect a second actuation of the PTT button on the smart radio device; and
in response to detecting a second actuation of the PTT button, duplicate the data into the first data duplicate and the second data duplicate, encode the first data duplicate and the second data duplicate, and transmit, simultaneously, the encoded first data duplicate and the encoded second data duplicate via the topic of the MQTT protocol to the computing device.

20. The non-transitory, computer-readable storage medium of claim 16, the smart radio device is further caused to:
generate the data, the generating comprising:
receiving an input,
wherein the input is an audible input or a text input; and
transforming the input to a digital form.
